(19) United States
(12) Patent Application Publication
(10) Pub. No.: US 2020/0104751 A1
(43) Pub. Date: Apr. 2, 2020

(54) CLASSIFICATION OF UNSEEN DATA

(71) Applicant: Hewlett Packard Enterprise Development LP, Houston, TX (US)

(72) Inventors: Madhusoodhana Chari Sesha, Bangalore (IN); Rangaprasad Sampath, Bangalore (IN)

(21) Appl. No.: 16/148,040

(22) Filed: Oct. 1, 2018

(51) Int. Cl. G06N 99/00; G06F 17/30

(52) U.S. Cl. CPC G06N 99/005; G06F 17/30598

(57) ABSTRACT

An example method can include classifying a data set based on a plurality of classifiers generated by inputting the data set into a supervised machine learning mechanism and determining a portion of the classified data set comprises unseen data based on the classification. The unseen data can include data having an attribute not seen by the data set prior to inputting the data set into the supervised machine learning mechanism. The example method can include generating an additional rule based on the unseen data portion, adding the additional rule to the plurality of classifiers, and classifying a new received piece of data based on the plurality of classifiers and the additional rule.

### BACKGROUND

A network, also referred to as a computer network or a data network, is a digital telecommunications network which allows nodes (e.g., computing devices, network devices, etc.) to share resources. In networks, nodes exchange data with each other using connections (e.g., data links) between nodes. These connections can be established over cable media such as wires or optic cables, or wireless media such as a wireless local area network (WLAN).

### BRIEF DESCRIPTION OF THE DRAWINGS

FIG. 1 is an example network device for classification of unseen data including a processing resource and a memory resource consistent with the present disclosure.

FIG. 2 is an example method for classification of unseen data consistent with the present disclosure.

FIG. 3 is an example table and sample space diagram consistent with the present disclosure.

FIG. 4 is an example decision tree consistent with the present disclosure.

FIG. 5 is an example separated sample space diagram consistent with the present disclosure.

FIG. 6 is another example separated sample space diagram consisted with the present disclosure.

FIG. 7 is an example decision tree for classification of unseen data consistent with the present disclosure.

FIG. 8 is an example system for classification of unseen data including a machine-readable medium (MRM) and a processor consistent with the present disclosure.

### DETAILED DESCRIPTION

Network traffic classification can include categorizing network traffic according to various attributes (e.g., port number, protocol, etc.) into traffic classes. Each resulting traffic class can be treated differently in order to differentiate a service implied for a data generator or consumer. Put another way, network traffic classification can include classification of network traffic flows on a network device such as a switch or router being classified into a plurality of attributes. Such attributes can include application name, application protocol, application type, and/or transport protocol, among others. Network traffic classification can enable network administrators and managers to gain network visibility, provision for bandwidth, detect security violations, and/or monitor application of and compliance with policies across the network which may result in the provision of an improved customer experience.

Some approaches to network traffic classification include port-based traffic identification, machine learning mechanisms, and payload-based approaches (e.g., Deep Packet Inspection (DPI)), among others. Such example approaches may use trained data sets to represent network traffic. However, some approaches, for instance machine learning mechanisms, may not accommodate types of network traffic that has not been seen in a training phase of network traffic data. For instance, unseen traffic (e.g., unseen by a training set) may be classified into a most probable class rather than being left unclassified. This can result in inaccurate and non-representative classification. For instance, without comprehensive and representative trained data sets, classifications may not be representative of a variety of network deployments across various consumer segments such as healthcare, university, enterprise campus, data centers, and/or branch offices, among others.

Examples of the present disclosure provide for detection of unseen data, also referred to as “novel” data. For instance, data not seen during a data training phase can be classified as “unknown” rather that classified into a most probable class. For example, unseen data may have a classification of “unknown”, whereas data that was seen may have a “known” classification. Once classified as unknown, alerts may be raised, for instance, to a network administrator that more representative data may result in improved network traffic classification.

Some examples of the present disclosure can affect the functionality of a network device (e.g., improve the functionality), such that the network device can perform functions associated with network user visibility. Network user visibility can include how data is collected and distributed in a network and how the data is being used. For instance, how users are using network bandwidth and how much network bandwidth is being used are examples of network user visibility. By determining that newly received data is “known” or “unknown”, enhanced network user visibility can be attained, which can improve network performance, for instance, by being used for network provisioning determinations, security profiling determinations, network anomaly identification, and bandwidth allocation determinations, among others.

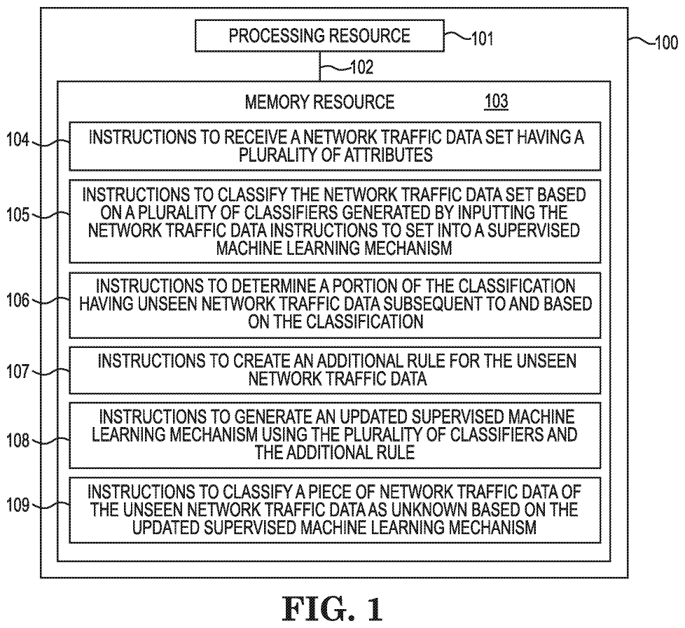

FIG. 1 is an example network device 100 for classification of unseen data including a processing resource 101 and a memory resource 103 consistent with the present disclosure. Unseen data, as used herein, includes data having an attribute not seen by the data set prior to inputting the data set into the supervised machine learning mechanism. A network device, as used herein, includes a device (e.g., physical device) used for communication and interaction between devices on a computer network. Network devices, such as network device 100 can mediate data in a computer network. Example network devices include switching devices (also known as “switches”), routers, router/switching device combinations, access points, gateways, and hubs, among others. In some instances, network device 100 can be or include a controller. Network device 100 can be a combination of hardware and instructions for classification of unseen data. The hardware, for example can include processing resource 101 and/or a memory resource 103 (e.g., MRM, computer-readable medium (CRM), data store, etc.).

Processing resource 101 (e.g., a processor), as used herein, can include a number of processing resources capable of executing instructions stored by a memory resource 103. The instructions (e.g., machine-readable instructions (MRI)) can include instructions stored on the memory resource 103 and executable by the processing resource 101 to implement a desired function (e.g., classification of unseen data). The memory resource 103, as used herein, can include a number of memory components capable of storing non-transitory instructions that can be executed by processing resource 101. Memory resource 103 can be integrated in a single device or distributed across multiple devices. Further, memory resource 103 can be fully or partially integrated in the same device as processing resource 101 or it can be separate but accessible to that device and processing resource 101. Thus, it is noted that the network device 100 can be implemented on an electronic device and/or a collection of electronic devices, among other possibilities.

The memory resource 103 can be in communication with the processing resource 101 via a communication link (e.g., path) 102. The communication link 102 can be local or remote to an electronic device associated with the processing resource 101. The memory resource 103 includes instructions 104, 105, 106, 107, 108, and 109. The memory resource 103 can include more or fewer instructions than illustrated to perform the various functions described herein. In some examples, instructions (e.g., software, firmware, etc.) 104, 105, 106, 107, 108, and 109 can be downloaded and stored in memory resource 103 (e.g., MRM) as well as a hard-wired program (e.g., logic), among other possibilities.

Instructions 104, when executed by a processing resource such as processing resource 101 can receive a network traffic data set having a plurality of attributes. For instance, the network traffic data set can be received from a network packet location. A network packet location (e.g., geographic location, virtual location, subnet location, address space location, etc.) can include a location in the network that captures information associated with packets coming into a network device such as a switching device (e.g., switch, router, etc.) at a port of the switching device. The plurality of attributes can include information or a specification associated with the network traffic data set that defines a property of the data within the network data set such as application protocol information (e.g., Hypertext Transfer Protocol (HTTP), File Transfer Protocol (FTP), Hypertext Transfer Protocol Secure (HTTPS), etc.) application name information (e.g., Skype, Gmail, etc.), application type information (e.g., streaming video, chat, etc.), and/or transport protocol information, among others. Each attribute can have a value that is a representation of some entity that can be manipulated by a program.

Instructions 105, when executed by a processing resource such as processing resource 101 can classify the network traffic data set based on a plurality of classifiers generated by inputting the network traffic data set into a supervised machine learning mechanism. An example supervised learning mechanism is a decision tree classifier. A decision tree classifier is a classifier that can be interpreted in the form of a tree that contains decision nodes and leaves. Each internal node represents a “test” on an attribute, each branch represents the outcome of the test, and each leaf node represents a class label (e.g., a decision taken after computing all data attributes). The paths from root to leaf represent classification rules. Once built, a new piece of data is classified according to the classification rules that decide based on attributes.

A supervised learning mechanism based on the decision tree classifier can be built using training data samples that have been seen in the training data samples. For instance, it cannot account for or create placeholders for test data that has not been seen (“unseen” data) in the training data samples. As such, once a decision tree classifier supervised learning mechanism is built, test data is classified to a probable class in the decision tree rather than being left unclassified, regardless of dissimilarity to the training data samples in the probable class in the decision tree.

In contrast, some examples of the present disclosure can use a supervised learning mechanism based on a decision tree classifier but can classify unseen data as unknown (leave it unclassified), as compared to classifying it into a probable class. For instance, the supervised learning mechanism can proceed, and examples of the present disclosure can act as a post-processing phase to classify the unseen data.

Instructions 106, when executed by a processing resource such as processing resource 101 can determine a portion of the classification having unseen network traffic data subsequent to and based on the classification. Unseen network traffic data can include network data having one of the plurality of attributes not seen by a trained network traffic data set during a training phase. In some examples, traffic data can include network data having more than one of the plurality of attributes not seen by the trained network traffic data set during the training phase. A range of unseen values in the network traffic data set can be determined based on the classification. By creating boundaries corresponding to nodes of the decision tree, a determination can be made as to ranges of attribute values where a piece of new data may fall that has not been seen by the trained network traffic data set.

Instructions 107, when executed by a processing resource such as processing resource 101 can create an additional rule for the unseen network traffic data. In some instances, the additional rule can be created based on the range of unseen values. For example, the additional rule can be based on attribute value ranges unseen by the trained network traffic data set in which a new piece of data may fall. The result of this rule is a classification of “unknown”. For instance, instead of classifying a new piece of network traffic data into a most probable class, a new classification of unknown becomes available, which is more accurate and can indicate when further training of a trained data set may be appropriate.

Instructions 108, when executed by a processing resource such as processing resource 101 can generate an updated supervised machine learning mechanism using the plurality of classifiers and the additional rule. As used herein, an updated supervised machine learning mechanism can include the supervised machine learning mechanism using the decision tree classifier with the additional rule. For instance, the additional rule is added to the existing mechanism (e.g., decision tree), such that existing mechanism does not change. Put another way, the “updated supervised machine learning mechanism”, may be referred to as an update in the supervised machine learning mechanism.

Instructions 109, when executed by a processing resource such as processing resource 101 can classify a piece of network traffic data of the unseen network traffic data as unknown or known based on the updated supervised machine learning mechanism. For instance, a new network traffic data set can be received, and a first portion of the new network traffic data set can be classified as known responsive to the first portion corresponding to one of the plurality of classifiers while a second portion of the new network traffic data set can be classified as unknown responsive to the second portion corresponding to the additional rule. A known classification (which may be a specific attribute) can result from the new piece of data having been seen by the trained data set, while an unknown classification can result from the new piece of network traffic data having not been seen by the trained data set on which the supervised machine learning mechanism is based.

In some instances, an alert can be provided to retrain the trained network traffic data set responsive to classification of a threshold number of pieces of data as unknown. For instance, upon 20 percent (or some other pre-determined threshold) of new pieces of data being classified as unknown, an alert may be generated and provided to an administrator suggesting retraining of the trained network traffic data, as the trained network traffic data may have fallen below a desired comprehensiveness and/or representativeness.

Once the updated supervised machine learning mechanism is generated, new pieces of network traffic data can be classified dynamically as they are received by network device 100. As used herein, dynamically can include variable and/or constantly changing in response to a particular influence (e.g., a new piece of network traffic data received by network device 100). The classification can be used to gain insights into network user activity and gain network user visibility including, for instance, what kind of network traffic is on the network. This can include percentages of usage types by application, types of user activities using network bandwidth, and network technicalities (e.g., protocols), among others. Knowing this information can allow for adjustment and or creation of policies such as blocking particular applications, tracking pirated content, tracking bandwidth usage, putting bandwidth limits in place, provisioning bandwidths, etc.

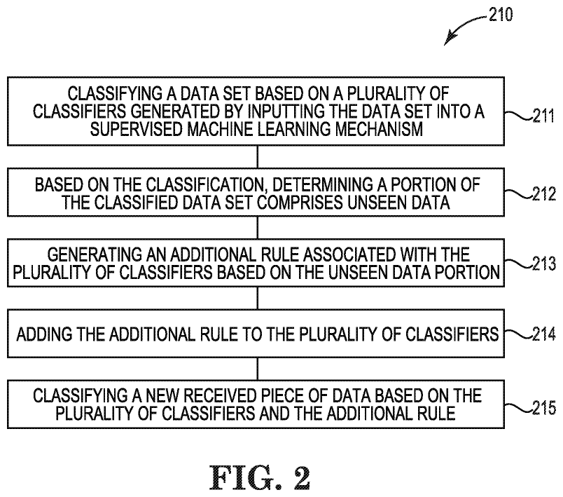

FIG. 2 is an example method 210 for classification of unseen data consistent with the present disclosure. Method 210 can be performed by a network device, such as network device 100, which can include a controller in some examples. A controller, for instance, can include a hardware device and/or instructions implemented on a plurality of hardware devices such as switches or routers, among others.

At 211, method 210 can include classifying a data set based on a plurality of classifiers generated by inputting the data set into a supervised machine learning mechanism. For instance, the supervised machine learning mechanism, which may be a decision tree machine learning mechanism, can output classifiers associated with attributes of the data set.

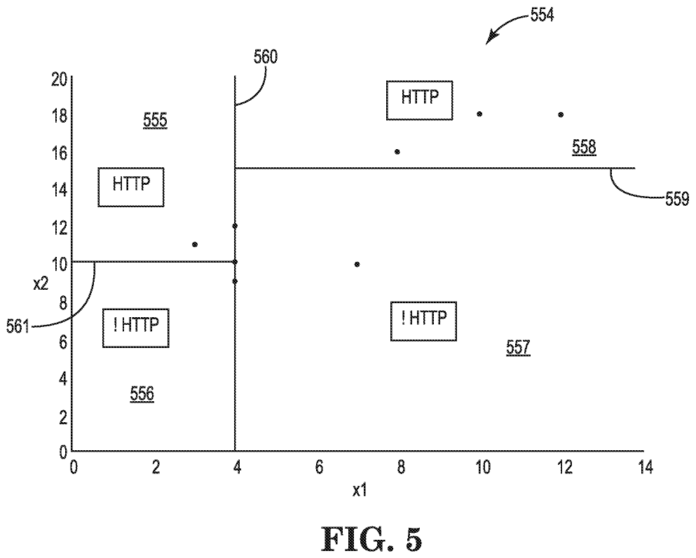

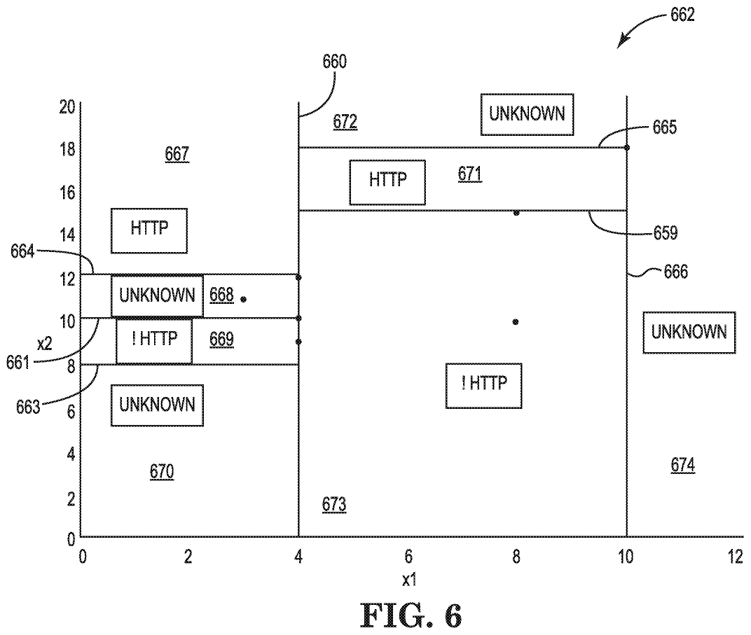

At 212, method 210 can include determining a portion of the classified data set comprises unseen data based on the classification. As noted, unseen data, as used herein, includes data having an attribute not seen by the data set prior to inputting the data set into the supervised machine learning mechanism. In some examples, unseen data includes data having a plurality of attributes not seen by the data set prior to inputting the data set into the supervised machine learning mechanism. The supervised machine learning mechanism may have been generated based on a trained data set. If, during a training phase, the data set encountered attributes A, B, and C, but not attribute D. Because no classifier would have been built specifically for D, it is unseen data. Boundaries associated with values of the attributes can be created to determine where portions of the classified data set having unseen data may be. For instance, a boundary may be placed between attribute C and D such that data on the C-side of the boundary is seen data, while data on the D-side of the boundary is unseen data. Boundary examples are illustrated and described further herein with respect to FIGS. 5 and 6.

Some examples of the present disclosure can allow for unseen data classification in a domain where it may be challenging to get an exhaustive and representative data set of a challenging space. Such a challenging space can include network traffic generated by applications in a network. This may be challenging because the types of traffic vary with each deployment and change with deployment of newer applications. Examples of the present disclosure can allow for classifying different types of data sets as seen or unseen including network data sets generated by applications in the network, resulting in improved network traffic visibility.

Method 210, at 213, can include generating an additional rule based on the unseen data portion. For instance, the additional rule can create an “unknown” classification, such that unseen data is classified as unknown, as opposed to being classified in a most probable class seen in a training phase. Generating the additional rule can include, for instance, separating attributes of the data set into seen and unseen data subsequent to classification of the data set. For instance, the generating the additional rule can be performed in a post-processing phase.

At 214, method 210 can include adding the additional rule to the plurality of classifiers. For instance, an updated decision tree can be created to include the new rule and output new “unknown” classifications. At 215, method 210 can include classifying a new received piece of data based on the plurality of classifiers and the additional rule. For instance, the new piece of data can be classified as a known piece of data or an unknown piece of data based on the plurality of classifiers and the additional rule. For instance, if seen in training, the new piece of data can be classified as known (which can include a particular attribute as its classification). If not seen in training, the new piece of data can be classified as unknown. In some examples, determining the portion of the classified data set comprises unseen data, generating the additional rule, adding the additional rule, and classifying the new received piece of data can be performed subsequent to classifying the data set. For instance, the aforementioned procedures can be performed in a post-processing phase.

In some examples, the method 210 can be performed continuously, meaning new pieces of data can be dynamically and/or continuously classified responsive to new pieces of data being received. For instance, new pieces of data can be continuously received and dynamically classified as they are received.

The continuous and/or dynamic classification can be used to determine network information that provides insights and guidance regarding network utilization, network reachability, network user behavior, etc., that can be used for provisioning of value-added services in the network. Put another way, recognizing patterns and classifications associated with traffic on the network can provide insight into users' behavior, which can be used to improve user experience (e.g., deploy more hardware, deploy more services, etc.) on the network in some examples.

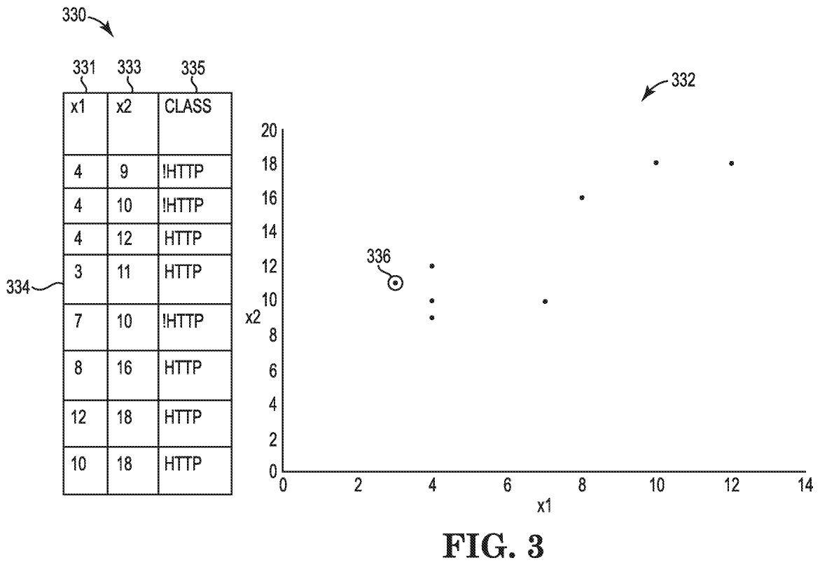

FIG. 3 is an example table 330 and sample space diagram 332 consistent with the present disclosure. Table 330 includes two attributes, x1 331 and x2 333, of the data set, which are independent variables and are illustrated along with a class label 335, which is a dependent variable. Attributes x1 331 and x2 333 can represent a property of network data (e.g., packets) that are incident on a network. The class label 335 specifies, in this example, whether the specific row of the data set represents an HTTP packet or not an HTTP packet (denoted by !HTTP). While two attributes are described in this example, more or fewer attributes may be associated with the data set (e.g., the data set can be n-dimensional). The data set in table 300 is represented in sample space diagram 332. The x-axis in sample space diagram 332 represent attribute x1 and the y-axis represents attribute x2. For example, row 334 of table 300 includes x1 at 3 (x1 on the x-axis), x2 at 11 (x2 on the y-axis), resulting in point 336.

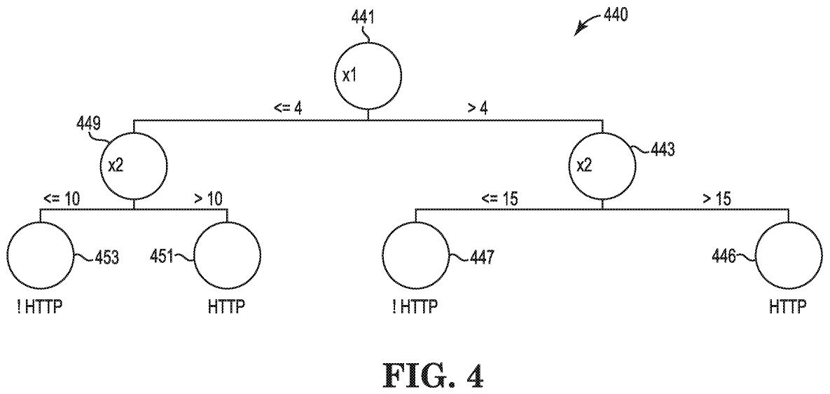

FIG. 4 is an example decision tree 440 consistent with the present disclosure. Decision tree 440, in this example, is built from the data set illustrated in table 300 and sample space diagram 332. Put another way, decision tree 440 creates boundaries associated with the data set of table 300 that will be discussed further herein with respect to FIG. 5. The attribute values and boundaries of decision tree 440 correspond to x1 and x2 values illustrated in table 330 and sample space diagram 332.

For instance, using decision tree 440, it would first be determined at 441 whether a new piece of data has an x1 attribute value greater than 4 or less than or equal to 4. If it is determined at 441 that the x1 attribute value is greater than 4, a determination can be made at 443 if the new piece of data has an x2 attribute value greater than 15 or less than or equal to 15. If it is determined at 443 that the x2 attribute value is greater than 15, the new data can be classified at 446 as representing an HTTP packet. If, at 443, it is determined that the x2 attribute value is less than or equal to 15, the new data can be classified at 447 as representing a not HTTP packet.

If, at 441, it is determined that the x1 attribute value is less than or equal to 4, a determination can be made at 449 if the new piece of data has an x2 attribute value of greater than 10 or less than or equal to 10. If it is determined at 449 that the x2 attribute value is greater than 10, the new data can be classified at 451 as representing an HTTP packet. If, at 449, it is determined that the x2 attribute value is less than or equal to 10, the new data can be classified at 453 as representing a not HTTP packet.

In some examples, any number of boundary values can be used, and the decision tree classifier may not be binary. The value of ranges may not be continuous, and/or a same attribute can be classified differently at different depths in different branches of the decision tree classifier. In some examples, a sequence of attributes from root to each leave may not follow a same order.

FIG. 5 is an example separated sample space diagram 554 consistent with the present disclosure. For instance, separated sample space diagram 554 illustrates boundaries 559, 560, and 561 created by decision tree 440 of FIG. 4. With these boundaries, the regions 555, 556, 557, and 558 in sample space diagram 554 are classified as regions that represent HTTP or not HTTP. For example, referring to decision tree 440, a boundary 560 is formed on sample space diagram 554 at x1=4 to illustrate the decision made at 441. A boundary 558 is formed at x2=15 to illustrate the decision made at 443, and a boundary 561 is formed at x2=10 to illustrate the decision made at 449. Once the boundaries are in place, regions 555, 556, 557, and 558 are formed representing HTTP and not HTTP data. For instance, classification 453 is illustrated in region 556, classification 451 is illustrated in region 555, classification 447 is illustrated in region 557, and classification 446 is illustrated in region 558.

Once the classifier illustrated in decision tree 440 is built, a new data point (x1, x2) that has not been seen in a training data set is classified per the boundaries of decision tree 440. However, this can result in new data that is dissimilar to training data set samples being classified to a most probable class in decision tree 440 rather than being left unclassified. To address this, some examples of the present disclosure break down numerical values of attributes associated with the data set (e.g., x1 and x2 attributes) into ranges of values that are either seen in the training data or unseen.

For instance, considering the attributes x1 and x2 based on the training data set of table 330, x1 includes seen ranges of less than or equal to 4 and greater than 4. x1 includes an unseen range of greater than 10. x2 includes seen ranges of 8 to 10, 12 to 15, and 15 to 18. x2 includes unseen ranges of less than or equal to 8, 10 to 12, and greater than 18. The ranges for the individual attributes can be combined to determine seen and unseen regions, as illustrate in FIG. 6.

For instance, FIG. 6 is another example separated sample space diagram 662 consisted with the present disclosure. Separated sample space diagram 662 includes boundaries 659, 660, and 661 which may be analogous to boundaries 559, 560, and 561, respectively, of FIG. 5. For instance, these boundaries correspond to decision tree 440. Separated sample space diagram 662 also includes boundaries 663, 664,665, and 666 which correspond to the aforementioned unseen ranges and decision tree 775, which will be discussed further herein.

For instance, when the seen and unseen ranges are combined and mapped on separated sample space diagram 662, regions 667, 669, 671, and 673 include data ranges that were seen in the training data set and can be labeled with classifications (e.g., HTTP and not HTTP). Regions 668, 670, 672, and 674 include data ranges not seen in the training data set and can be labeled with an “unknown” classification. Regions 668, 670, 672, and 674 labeled as unknown represent novelty meaning these regions are where new data is appearing.

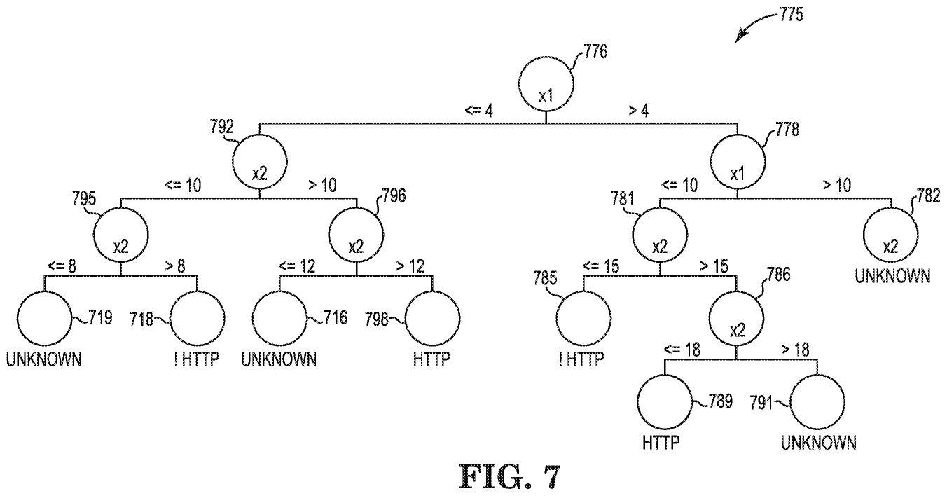

FIG. 7 is another example decision tree 775 for classification of unseen data consistent with the present disclosure. While decision tree 775 is illustrated as a binary decision tree classifier (e.g., it classifies as HTTP or not HTTP), multi-class decision trees having greater than two classifications can be used. In such an example, leaf nodes of the multi-class decision tree can be named HTTP-1, HTTP-2, . . . , HTTP-m or not HTTP-1, not HTTP-2, . . . , not HTTP-p. By doing this, the unknown leaf nodes can be unknown-1, unknown-2, . . . , unknown-q.

Unseen data can be added to already-built decision tree 440 to create an updated decision tree 775. For instance, the updated decision tree 775 can be built post-processing such that updating decision tree 440 to decision tree 775 does not change the basic mechanism of the decision tree classifiers of decision tree 440. “Unknown” labels can be added as applicable to decision tree 775. The unknown classifications (e.g., unknown leaf nodes) represent the regions (e.g., “novel” regions) to where data can be mapped.

For instance, using decision tree 770, it would first be determined at 776 whether a new piece of data has an x1 attribute value greater than 4 or less than or equal to 4. If it is determined at 776 that the x1 attribute value is greater than 4, a determination can be made at 778 if the new piece of data has an x1 attribute value greater than 10 or less than or equal to 10. If it is determined at 778 that the x1 attribute value is greater than 10, the new data can be classified at 782 as unknown. If, at 778, it is determined that the x1 attribute value is less than or equal to 10, a decision can be made at 781 as to whether the x2 attribute value is greater than 15 or less than or equal to 15. If it is determined at 781 that the x2 value is less than or equal to 15, the new data can be classified as representing a not HTTP packet at 785. If it is determined at 781 that the x2 attribute value is greater than 15, a determination can be made at 786 as to whether the x2 attribute value is greater than 18 or less than or equal to 18.

If, at 786, it is determined the x2 attribute value is greater than 18, the new piece of data can be classified as unknown at 791. If, at 786, it is determined the x2 attribute value is less than or equal to 18, the new piece of data can be classified as representing an HTTP packet at 789.

If, at 776, it is determined that the x1 attribute value is less than or equal to 4, a determination can be made at 792 if the new piece of data has an x2 attribute value of greater than 10 or less than or equal to 10. If it is determined at 792 that the x2 attribute value is greater than 10, a determination can be made at 796 if the new piece of data has an x2 attribute value greater than 12 or less than or equal to 12. If it is determined at 796 that the x2 attribute value is greater than 12, the new piece data can be classified at 798 as representing an HTTP packet. If, at 796, it is determined that the x2 attribute value is less than or equal to 12, the new piece of data can be classified as unknown at 716.

If, at 792, it is determined that the x2 attribute value is less than or equal to 10, a determination can be made at 795 as to whether the x2 attribute value is greater than 8 or less than or equal to 8. If it is determined the x2 attribute value is greater than 8, the new piece of data can be classified at 718 as representing a not HTTP packet. If, at 795, it is determined the x2 attribute value is less than or equal to 8, the new piece of data can be classified at 719 as unknown.

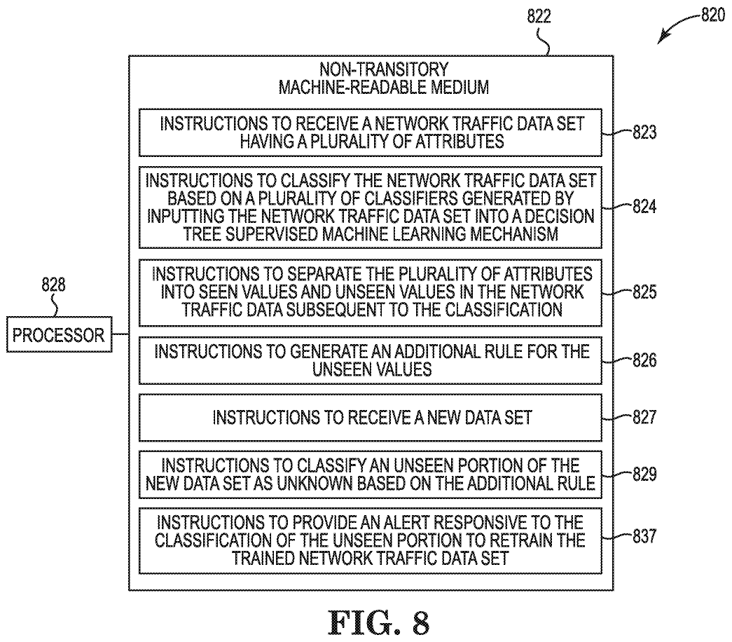

FIG. 8 is an example system 820 for classification of unseen data including an MRM 822 and a processor 828 (or other processing resource) consistent with the present disclosure. In some examples, system 820 can be a device akin to network device 100 as illustrated in FIG. 1. For instance, system 820 can be a computing device in some examples and can include a processor 828. System 820 can further include a non-transitory MRM 822, on which may be stored instructions, such as instructions 823, 824, 825, 826, 827, 829, and 837. Although the following descriptions refer to a processing resource and an MRM, the descriptions may also apply to a system with multiple processing resources and multiple MRMs. In such examples, the instructions may be distributed (e.g., stored) across multiple non-transitory MRMs and the instructions may be distributed (e.g., executed by) across multiple processing resources. Processor 828 and non-transitory MRM 822 can be akin to the processing resource and memory resource described with respect to FIG. 1.

Non-transitory MRM 822 may be electronic, magnetic, optical, or other physical storage device that stores executable instructions. Thus, non-transitory MRM 822 may be, for example, Random Access Memory (RAM), an Electrically-Erasable Programmable Read-Only Memory (EEPROM), a storage drive, an optical disc, and the like on-transitory MRM 822 may be disposed within system 820, as shown in FIG. 2. In this example, the executable instructions 823, 824, 825, 826, 827, and 829 may be “installed” on the device. Additionally and/or alternatively, non-transitory MRM 822 can be a portable, external or remote storage medium, for example, that allows system 820 to download the instructions 823, 824, 825, 826, 827, and 829 from the portable/external/remote storage medium. In this situation, the executable instructions may be part of an “installation package”. As described herein, non-transitory MRM 822 can be encoded with executable instructions for classification of unseen data.

Instructions 823, when executed by a processing resource such as processor 828, can include instructions to receive a network traffic data set having a plurality of attributes, and instructions 824, when executed by a processing resource such as processor 828, can include instructions to classify the network traffic data set based on a plurality of classifiers generated by inputting the network traffic data set into a decision tree supervised machine learning mechanism. The decision tree supervised machine learning mechanism can be based on a trained network traffic data set in some examples. The trained network traffic data set can include, for instance, network application protocol data, network transport protocol data, and/or network user activity data, among others.

Instructions 825, when executed by a processing resource such as processor 828, can include instructions to separate the plurality of attributes into seen values and unseen values in the network traffic data subsequent to the classification. For instance, ranges of values that were not present in the trained network traffic data set can be determined, and these ranges of values can be labeled as unseen.

Instructions 826, when executed by a processing resource such as processor 828, can include instructions to generate an additional rule for the unseen values. The additional rule can be added to the plurality of classifiers such that the plurality of classifiers remains unchanged subsequent to the addition of the additional rule. For instance, the additional rule can correspond to the unseen values such that an “unknown” classification becomes possible, as opposed to classification of unseen data into a most probable class that may be incorrect. The additional rule can be added to the plurality of classifiers such that an updated decision tree is created. This can be done post-processing, such that the original aspects of the decision tree remain, with an addition of the additional rule. The decision tree expands, but original values of the decision tree are not lost.

Instructions 827, when executed by a processing resource such as processor 828, can include instructions to receive a new data set, and instructions 829, when executed by a processing resource such as processor 828, can include instructions to classify an unseen portion of the new data set as unknown based on the additional rule. For instance, upon receipt of a new piece of data that is unseen, rather than classifying the new piece of data in a most probable class, it can be classified as unknown. A new piece of data may be classified as known (or as a particular attribute) if it is seen data. For instance, the new piece of data may fall into original values and classifiers of the pre-updated decision tree.

Instructions 837, when executed by a processing resource such as processor 828 can include instructions to provide an alert responsive to the classification of the unseen portion to retrain the trained network traffic data set. For instance, the alert can be provided responsive to a threshold amount (e.g., 5 percent, 10 percent, 15 percent, 20 percent etc.) of the new data set being classified as unknown. An administrator may receive an alert suggesting the trained network traffic data set has fallen below a desired comprehensiveness or representativeness based on a percentage of unknown classifications. Retraining may be suggested to improve comprehensiveness and/or representativeness.

In the foregoing detail description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. Further, as used herein, “a number of” an element and/or feature can refer to any number of such elements and/or features.

What is claimed:

1. A method, comprising:
classifying, by a controller, a data set based on a plurality of classifiers generated by inputting the data set into a supervised machine learning mechanism;
based on the classification, determining, by the controller, a portion of the classified data set comprises unseen data,
wherein unseen data comprises data having an attribute not seen by the data set prior to inputting the data set into the supervised machine learning mechanism;
generating, by the controller, an additional rule based on the unseen data portion;
adding, by the controller, the additional rule to the plurality of classifiers; and
classifying, by the controller, a new received piece of data based on the plurality of classifiers and the additional rule.

2. The method of claim 1, further comprising classifying the new piece of data as a known piece of data based on the plurality of classifiers and the additional rule.

3. The method of claim 1, further comprising classifying the new piece of data as an unknown piece of data based on the plurality of classifiers and the additional rule.

4. The method of claim 1, further comprising generating, by the controller, the plurality of classifiers by inputting the data set into a decision tree machine learning mechanism.

5. The method of claim 1, wherein classifying the data set comprises classifying network traffic data sets generated by applications in the network.

6. The method of claim 1, wherein generating the additional rule comprises separating attributes of the data set into seen and unseen data subsequent to classification of the data set.

7. The method of claim 1, further comprising determining the portion of the classified data set comprises unseen data, generating the additional rule, adding the additional rule, and classifying the new received piece of data subsequent to classifying the data set.

8. A network device comprising a processor in communication with a memory resource including instructions executable by a processor to:
receive a network traffic data set having a plurality of attributes;
classify the network traffic data set based on a plurality of classifiers generated by inputting the network traffic data set into a supervised machine learning mechanism;
subsequent to and based on the classification, determine a portion of the classification having unseen network traffic data;
create an additional rule for the unseen network traffic data;
generate an updated supervised machine learning mechanism using the plurality of classifiers and the additional rule; and
classify a piece of network traffic data of the unseen network traffic data as unknown based on the updated supervised machine learning mechanism.

9. The network device of claim 8, wherein the instructions executable to determine a portion of the classification having unseen network traffic data are further executable to determine a range of unseen values in the network traffic data set based on the classification.

10. The network device of 9, further comprising instructions executable to create the additional rule based on the range of unseen values.

11. The network device of claim 8, wherein:
the supervised machine learning mechanism is based on a trained network traffic data set; and
the unseen network traffic data comprises network traffic not seen during a training phase of the trained network traffic data set.

12. The network device of claim 8, wherein:
the supervised machine learning mechanism is based on a trained network traffic data set; and
the instructions are further executable to provide an alert to retrain the trained network traffic data set responsive to classification of a threshold number of pieces of data as unknown.

13. The network device of claim 8, wherein:
the supervised machine learning mechanism is based on a trained network traffic data set; and
unseen network traffic data comprises network data having one of the plurality of attributes not seen by the trained network traffic data set during a training phase.

14. The network device of claim 8, wherein the instructions are further executable to
receive a new network traffic data set;
classify a first portion of the new network traffic data set as known responsive to the first portion corresponding to one of the plurality of classifiers; and
classify a second portion of the new network traffic data set as unknown responsive to the second portion corresponding to the additional rule.

15. A non-transitory computer-readable medium storing instructions executable by a processor to:
receive a network traffic data set having a plurality of attributes;
classify the network traffic data set based on a plurality of classifiers generated by inputting the network traffic data set into a decision tree supervised machine learning mechanism,
wherein the decision tree supervised machine learning mechanism is based on a trained network traffic data set;
subsequent to the classification, separate the plurality of attributes into seen values and unseen values in the network traffic data;
generate an additional rule for the unseen values;
receive a new data set;
classify an unseen portion of the new data set as unknown based on the additional rule; and
provide an alert responsive to the classification of the unseen portion to retrain the trained network traffic data set.

16. The medium of claim 14, wherein the instructions executable to generate the additional rule are further executable to add the additional rule to the plurality of classifiers such that the plurality of classifiers remains unchanged subsequent to the addition of the additional rule.

17. The medium of claim 14, further comprising instructions executable to provide the alert responsive to a threshold amount of the new data set being classified as unknown.

18. The medium of claim 14, wherein the trained network traffic data set comprises network application protocol data.

19. The medium of claim 14, wherein the trained network traffic data set comprises network transport protocol data.

20. The medium of claim 14, wherein the trained network traffic data set comprises network user activity data.
